(19) United States
(12) Patent Application Publication
(10) Pub. No.: US 2020/0095082 A1
(43) Pub. Date: Mar. 26, 2020

(54) Coated, Grooved Roll for Converting Line

(71) Applicant: Roto-Die Company, Inc., Eureka, MO (US)

(72) Inventor: Charles E. Schomber, JR., Catawissa, MO (US)

(21) Appl. No.: 16/568,783

(22) Filed: Sep. 12, 2019

Related U.S. Application Data
(60) Provisional application No. 62/733,740, filed on Sep. 20, 2018.
(60) Provisional application No. 62/848,621, filed on May 16, 2019.

(51) Int. Cl. B65H 20/02; B41F 21/00

(52) U.S. Cl. CPC B65H 20/02; B41P 2200/12; B65H 2404/1316; B41F 21/00

(57) ABSTRACT

A coated grooved roll is adapted for use on a web feed press of a converting processing line. The outer diameter surface has a coating adapted to repel adhesive and ink. In one aspect the roll is an idler roll. The outer diameter surface has a region with a plurality of circumferential grooves and adjacent lands each with an arcuate shape with a radius of between about 0.003 inches and about 0.007 inches after coating. In another aspect, the roll is a stripping roll with at least one flute adapted and configured to receive a contact assistance ring. On the outer diameter surface, the flat adjacent the flute has a plurality of circumferential grooves and adjacent lands each with an arcuate shape with a radius of between about 0.003 inches and about 0.007 inches after coating.

### RELATED APPLICATION DATA

This application claims the benefit of U.S. provisional application Ser. No. 62/733,740, filed Sep. 20, 2018, and U.S. provisional application Ser. No. 62/848,621, filed May 16, 2019, the disclosures of which are incorporated by reference herein.

### SUMMARY

This disclosure relates to web fed presses used in converting applications. In one aspect of the disclosure, the application includes flexographic printing and die cutting machinery used in converting applications. In one further aspect, the disclosure relates to an idler roll used for guiding, tensioning, and feeding webs of material for processing in the converting equipment. With respect to this aspect of the disclosure, an idler roll is presented with a grooved outer diameter surface with a coating that reduces both adhesive transfer and ink build-up. In another aspect, the disclosure relates to a roll with a grooved outer diameter surface with a coating that assists in waste matrix stripping and guiding and/or applying pressure to a die cut part. With respect to this aspect of the disclosure, a stripping roll is provided with one or more of flutes that receives a contact assistance ring for applying pressure to a die cut part. The lands adjacent the flute have the grooved outer diameter surface with the coating.

### DESCRIPTION OF THE DRAWINGS

FIG. 1 shows an exemplary die cutting unit with multiple idler rolls at least one of which may be a idler roll with a coated, grooved outer diameter surface, as described in more detail herein;

FIG. 2 is a cross-section view of an exemplary idler roll; and

FIG. 3 is a partial, enlarged cross-sectional view from detail area 3-3 of FIG. 2.

FIG. 4 shows an exemplary die cutting unit with a stripping roll with a coated, grooved outer diameter surface with flutes for receiving contact assistance rings, as described in more detail herein;

FIG. 5 shows a partial, perspective view of the exemplary die cutting unit of FIG. 4 showing a web being directed over an exemplary stripping roll that is applying pressure to remove waste matrix and strip the waste matrix from the web.

FIG. 6 is a cross-section view of an exemplary stripping roll;

FIG. 7 is a partial, enlarged cross-sectional view from detail area 7-7 of FIG. 6.

FIG. 8 is a partial, enlarged cross-sectional view from detail area 8-8 of FIG. 7.

### DETAILED DESCRIPTION

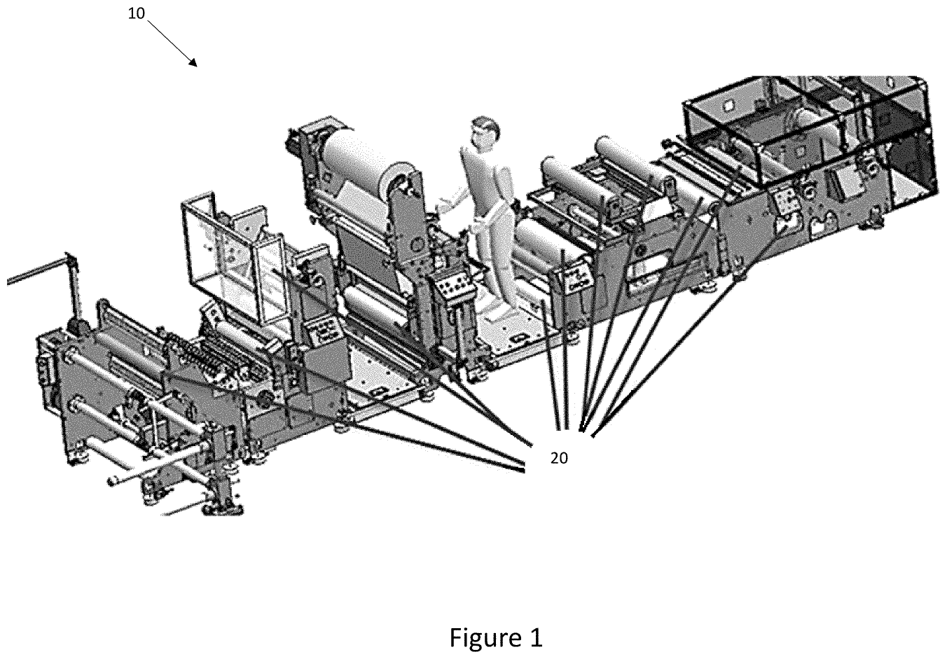

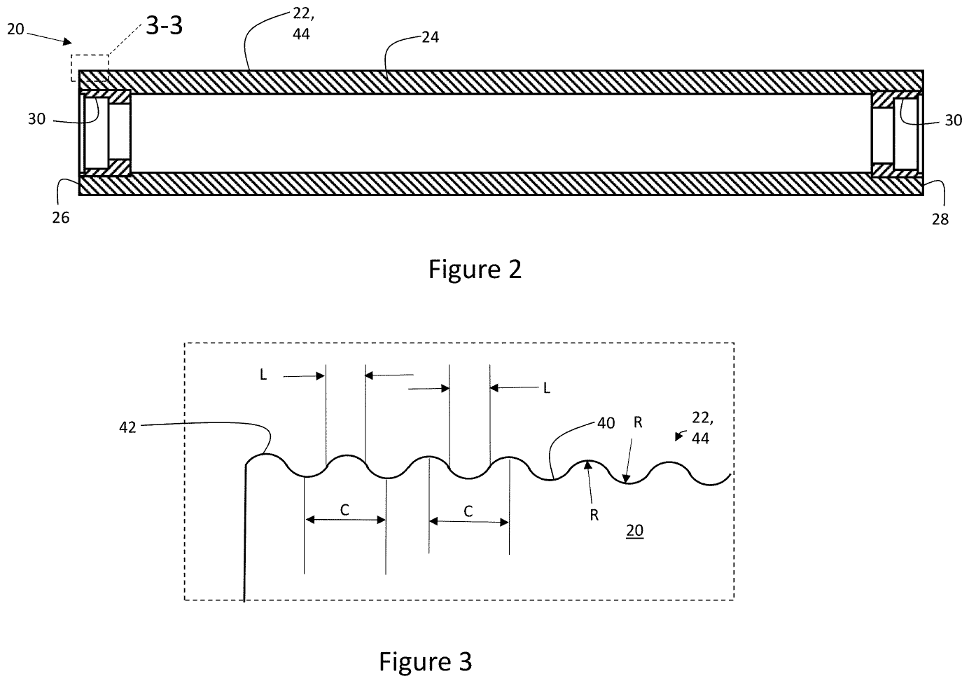

FIG. 1 shows an exemplary flexographic die cutting converting line 10. The exemplary idler roll 20 may be used in one or more locations for guiding, tensioning, and feeding webs of material for processing in the converting equipment. The idler roll 20 as described herein may be used in die cutting lines, printing lines, combination die cutting and printing lines and other web fed presses used in converting processes. As will be described, the idler roll 20 has a grooved outer diameter surface 22 which may be coated, for instance, with a non-stick coating, to reduce both adhesive transfer and ink build-up in a converting line. The exemplary idler roll had been found to significantly reduce ink pickup and transfer to the idler rolls within the converting platform as compared to the level of adhesive and ink transfer currently experienced on standard smooth or shot peened idler rolls.

The exemplary idler roll 20 may comprise a cylindrical body 24, which may be made from a lightweight aluminum material. Other materials may also be used. Axial ends 26,28 of the body may be formed with recessed, internal faces to receive conventional or low friction/low inertia bearings 30. The idler roll 20 and type of bearing 30 may be selected depending upon the application. For instance, the idler roll 20 and bearing 30 may be configured to rotate with a live shaft design (i.e., the shaft drives the idler roll) or dead shaft design (the idler rotates on a shaft).

The outer diameter surface 22 of the body 24 of the idler roll 20 may have a plurality of circumferential grooves 40 and corresponding lands 42 on a region of the outer diameter surface. The grooves 40 on the outer diameter surface 22 allow for the removal of trapped air between web and idler roll, which provides improved web traction and reduces web surge, slipping, and side to side movement common with smooth rolls or shot peened rolls. The grooves 40 on the outer diameter surface 22 also reduce surface area improving the nonstick feature of the idler roll. Further, the outer diameter surface 22 (including the grooves 40 and the lands 42) may be coated, for instance, with a non-stick coating 44, configured to reduce both adhesive transfer and ink build-up. The coating 44 may be polymer based. The coating 44 may be compatible, and otherwise compliant and safe, for the intended processes to be conducted on the converting line. For instance, the coating may be FDA compliant to allow use in the manufacture of wound care products, pharma labels, and packaging applications. The coating 44 may also be suitable for use with common label stocks, non-stick labels, release coatings, and films.

The grooves 40 and the lands 42 on the outer diameter surface 22 may be a consistent form in a region of the outer diameter surface 22 of the cylindrical body of the roll 20. The region may extend from one adjacent one axial end 26 of the cylindrical body of the roll to adjacent the opposite axial end 28 of the cylindrical body of the roll 20. The region may extend a less distance along a length of the cylindrical body of the roll. The grooves 40 and the lands 42 may be uniform in both height, depth, and spacing within the region. For example, providing uniform grooves and lands from adjacent one axial end of the roll to adjacent the opposite axial end of the roll assists in controlling venting and web handling. The outer diameter surface 22 of the roll may be machined or engraved to form the grooves 40 and the lands 42. The roll and the features of outer diameter surface (e.g., the grooves 40 and the lands 42) may have a less than 0.0005 total indicated run-out. The grooves and the lands 40,42 may have each have an arcuate shape. The circumferential grooves may have an arcuate shape with a radius of between about 0.003 inches and about 0.007 inches after coating. The circumferential lands may have an arcuate shape with a radius of between about 0.003 inches and about 0.007 inches after coating. The alternating radii may comprise a symmetrical wave pattern as shown in FIG. 3. The wave pattern may be formed with an alternating radii pattern (‘R’) of about 0.003 inches to about 0.007 inches after coating. More preferably, the wave pattern may be formed with an alternating radius (‘R’) of about 0.005 inches after coating. The length (‘L’) of each wave in the wave pattern (e.g., the length of a groove as measured from the transition point of a land to a groove on one side and a groove to a land on an opposite side, and the length of a land as measured from the transition point of a groove to a land on one side and a land to a groove on an opposite side) may have a dimension of about 0.005 inches to about 0.010 inches after coating. More preferably, the length (‘L’) of each wave in the wave pattern may have a dimension of about 0.0075 inches after coating. The distance (‘C’) between the center of each wave in the wave pattern (i.e., the center to center distance of a land and/or a groove) may have a dimension of about 0.015 inches to about 0.020 inches after coating. More preferably, the distance (‘C’) between the center of each wave in the wave pattern may have a dimension of about 0.0175 inches after coating.

The consistent uniform wave form provides for more constant web traction which has been found to improve performance. The idler roll described herein reduces down-time for cleaning and waste, and allows for higher production runs, and faster speeds. The idler roll is less expensive than conventional idler rolls and may easily be fixed or repaired if damaged.

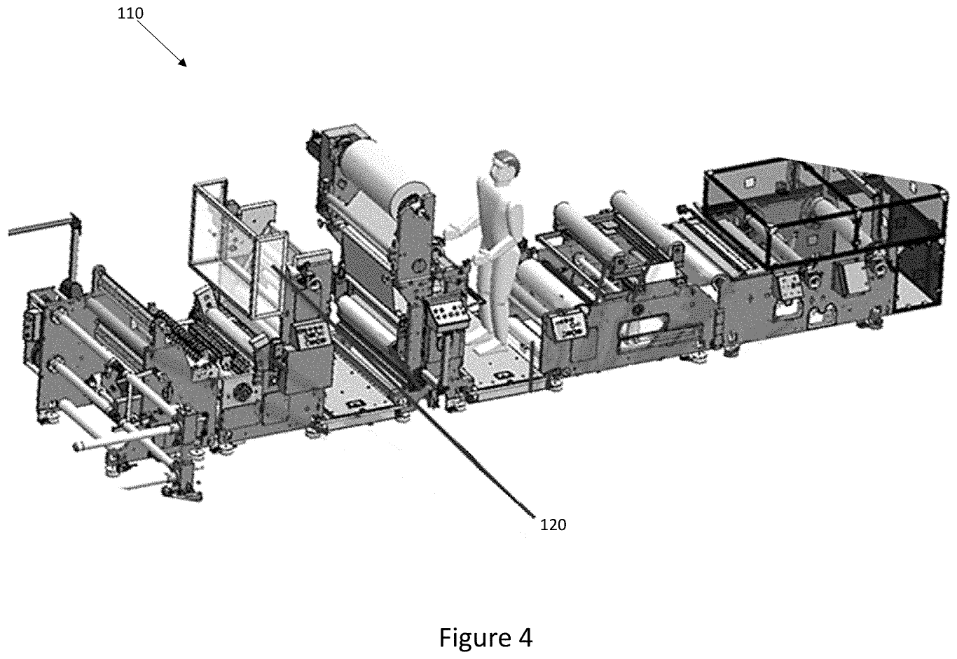

FIG. 4 shows a further exemplary flexographic die cutting converting line 110. An exemplary stripping roll 120 may be used in one or more locations for applying pressure to the web(s) to facilitate removal of waste matrix from a die cut part, and to strip away the waste matrix from the web during processing of the web in the converting equipment. The stripping roll 120 as described herein may be used in die cutting lines, printing lines, combination die cutting and printing lines and other web fed presses used in converting processes. As will be described, the stripping roll 120 has a fluted and grooved outer diameter surface 122 which may be coated, for instance, with a non-stick coating to reduce both adhesive transfer and ink build-up in a converting line. The exemplary stripping roll had been found to significantly reduce ink pickup and transfer to the stripping rolls within the converting platform as compared to the level of adhesive and ink transfer currently experienced on standard smooth or shot peened stripping rolls.

The exemplary stripping roll 120 may comprise a cylindrical body 124, which may be made from a lightweight aluminum. Other materials may also be used. Axial ends 126,128 of the body may be formed with recessed, internal faces to receive conventional or low friction/low inertia bearings 130. The stripping roll 120 and type of bearing 130 may be selected depending upon the application. For instance, the stripping roll 120 and bearing 130 may be configured to rotate with a live shaft design (i.e., the shaft drives the stripping roll) or dead shaft design (the stripping rotates on a shaft). The stripping roll may be manufactured to either machine width specifications or special lengths required by an operator of the die cutting converting line. Mounting hardware may also be included as needed depending upon the application and the nature of the die cutting converting line. The mounting hardware may be customized based on the converting machine design width or other customer requirements.

The outer diameter surface 122 of the body of the stripping roll may have one or more circumferential flutes 136 that are sized to accommodate contact assistance rings 150. The flutes 136 forms a corresponding plurality of flats 138 on the outer diameter surface 122 of the body of the stripping roll. Each of the flats 138 in the plurality of flats may have a plurality of grooves 140 and lands 142, as described above. As explained below, the outer diameter surface 122 may having a coating 144 applied to the flutes 136, the flats 138, the grooves 140, and the lands 142. The coating 144 may be configured to reduce both adhesive transfer and ink build-up.

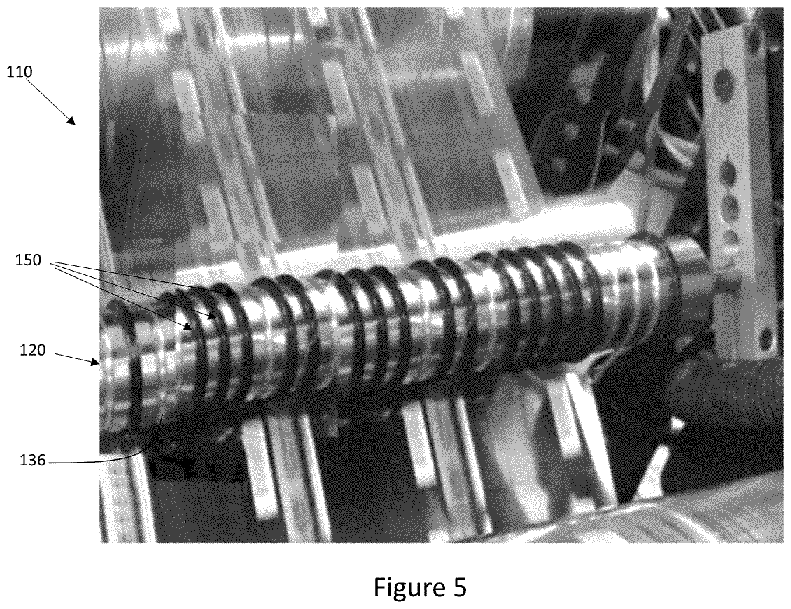

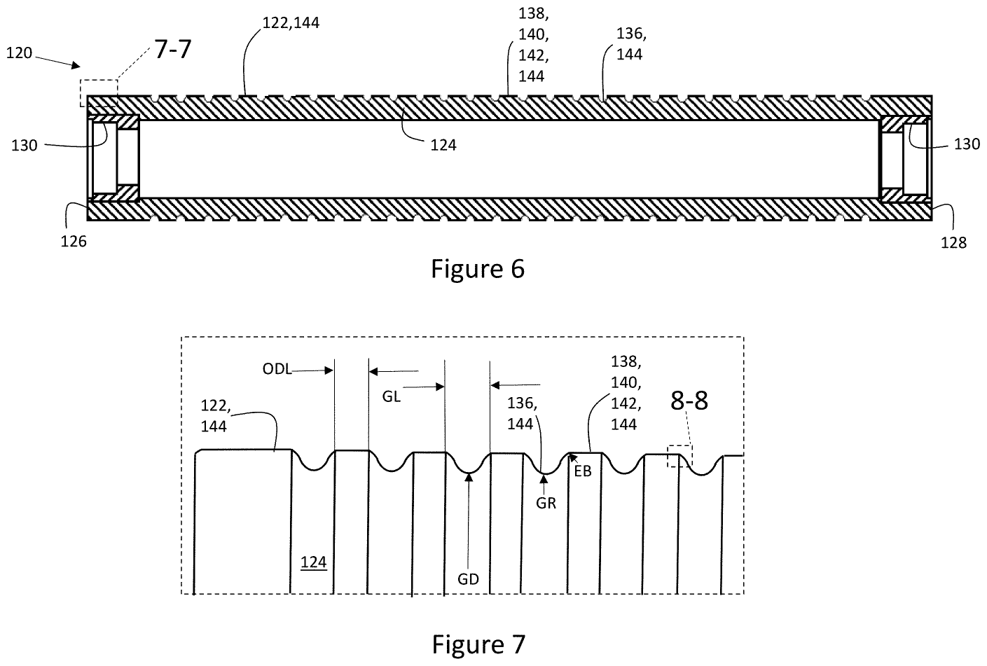

In one example, for instance, as shown in FIG. 6, the flutes 136 (and corresponding flats 138) on the outer diameter 122 may be a consistent stepped-type of form along a portion of the cylindrical body 124 of the roll 120. The portion may extend from adjacent one axial end 126 of the stripping roll to adjacent the opposite axial end 128 of the stripping roll 120. The flutes 136 and the flats 138 may be uniform in both height, depth, and spacing along the portion of or the entire roll (e.g., from adjacent one axial end of the roll to adjacent the opposite axial end of the roll), which allows the operator flexibility in placement of the contact assistance rings 150 as needed for a particular application. By way of example and not in any limiting sense, the flutes may be provided on ½ inch or 1 inch centers from adjacent one axial end 126 of the stripping roll 120 to adjacent the opposite axial end 128 of the stripping roll. This arrangement provides for in effect a universal stripping roll where placement of the contact assistance rings 150 in any one or more of the flutes may be varied from application to application as needed. In the alternative, the flutes may be formed in portion of the body of the roll as needed to match a specific product pattern to assist in applying pressure to the die cut part, and removing or stripping of the waste matrix. As shown in FIG. 5, the contact assistance rings 150 may be apply contact pressure on the die cut web to enable parts to be pressured onto a carrier web, which in turn allows for high speed waste matrix removal while reducing part lift due to adhesive strings or part design. The contact assistance rings 150 may be provided as needed along the length of the stripping roll 110 in accordance with the application and may be compatible with food grade, industrial, or medical application needs. The contact assistance rings 150 may comprise o-rings. The contact assistance rings 150 may comprise elastomers such as nitrile which is resistant to certain solvents, and/or silicone which is resistant to adhesive buildup. The operator may position the contact assistance rings strategically in one or more of the grooves on the stripping roll 110 to allow removal of waste matrix from the die cut part, which increases run speed while reducing downtime caused by the need to clean any surfaces of adhesive and/or ink buildup.

The flutes 136 and the flats 138 on the outer diameter surface of the stripping roll may be machined. In one example, for instance, as shown in FIG. 6, the flutes 136 and the lands 138 may comprise a symmetrical pattern. For a 2 inch nominal diameter stripping roll that is 30 inches long, the stripping roll may have 57 flutes placed on ½ inch centers. In one non-limiting example, the flutes 136 may be formed with a groove radius (‘GR’) of about 3/32 inches to about ⅛ inches after coating. More preferably, the flutes may have a groove radius (‘GR’) of about 0.105 inches after coating. At the outer diameter surface 122 where the flute 136 transitions to a flat 138, a gentle edge break (‘EB’) may be provided. Also, at the outer diameter surface 122 where the flute 136 transitions to a flat 138, each flute 136 in the pattern may have a groove length (‘GL’) of about 5/32 inches to about 7/32 inches after coating. More preferably, at the outer diameter surface 22 where the flute 136 transitions to a flat 138, the groove length (‘GL’) of each flute in the pattern may be about 0.198 inches after coating. At the outer diameter surface 122 where the flute 136 transitions to a flats 138, each flat 138 in the pattern may have a land length (‘ODL’) of about 9/32 inches to about 5/16 inches after coating. More preferably, at the outer diameter surface 122 where the flute 136 transitions to a flat 138, the land length (‘ODL’) of each flat 138 in the pattern may have a dimension of about 0.302 inches after coating. Each of the flutes 136 in the pattern may have a root diameter (‘GD’) of about 1 23/32 inches to about 1¾ inches after coating. More preferably, the groove root diameter (‘GD’) of each flute 136 in the pattern may be about 1.725 inches.

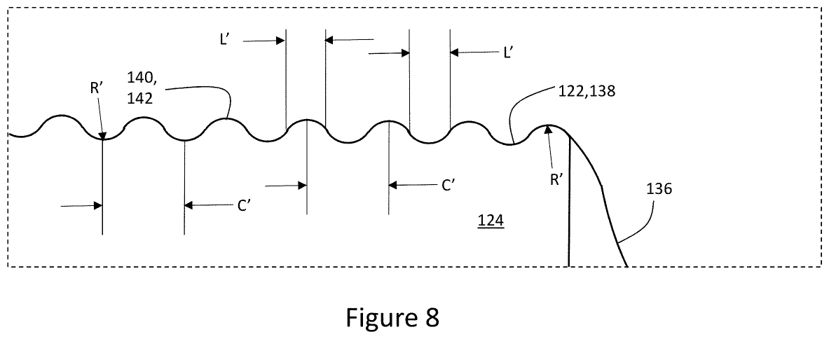

The grooves 140 and the lands 142 on the flat 138 of the outer diameter 122 of the stripping roll 120 may be a consistent form and may be centered on the flat 138. The grooves 140 and lands 142 may be uniform in both height, depth and spacing, and may be formed on each flat in the plurality of flats from adjacent one axial end of the stripping roll to the opposite axial end of the stripping roll, which controls venting and web handling. The grooves 140 and the lands 142 on each of the flats 138 may be machined or engraved. The stripping roll and its grooves 140 and its lands 142 may have a less than 0.0005 total indicated run-out. The grooves 140 and the lands 142 on each flat 138 may each comprise an arcuate shape with a radius of between about 0.003 inches and about 0.007 inches after coating. The alternating radii (‘R’) may comprise a symmetrical wave pattern as shown in FIG. 8. The wave pattern may be formed with an alternating radii pattern (‘R’) of about 0.003 inches to about 0.007 inches after coating. More preferably, the wave pattern may be formed with an alternating radius pattern (‘R′’) of about 0.005 inches after coating. The length (‘L′’) of each wave in the wave pattern (e.g., the length of a groove as measured from the transition point of a land to a groove on one side and a groove to a land on an opposite side, and the length of a land as measured from the transition point of a groove to a land on one side and a land to a groove on an opposite side) may have a dimension of about 0.006 inches to about 0.012 inches after coating. More preferably, the length (‘L′’) of each wave in the wave pattern may have a dimension of about 0.0087 inches after coating. The distance (‘C′’) between the center of each wave in the wave pattern (i.e., the center to center distance of a land and/or a groove) may have a dimension of about 0.015 inches to about 0.020 inches after coating. More preferably, the distance (‘C′’) between the center of each wave in the wave pattern may have a dimension of about 0.0173 inches after coating.

The flutes 136 and the grooved flats 138 allow for the removal of trapped air between web and stripping roller, which provides improved web traction and reduces web surge, slipping, and side to side movement common with smooth rolls or shot peened rolls. The flutes 136 and the grooved flats 138 also reduce surface area improving the nonstick feature of the stripping roll. The coating 144 may be compatible, and otherwise compliant and safe, for the intended processes to be conducted on the converting line. For instance, the coating may be FDA compliant to allow use in the manufacture of wound care products, pharma labels, and packaging applications. The coating 144 may also be suitable for use with common label stocks, non-stick labels, release coatings, and films.

The flutes 136 and the grooved flats 138 provide for more constant web traction which has been found to improve performance. The stripping roll described herein reduces down-time for cleaning and waste, and allows for higher production runs, and faster speeds. The stripping roll is less expensive than conventional stripping rolls and may easily be fixed or repaired if damaged.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A roll for a web fed press of a converting processing line, the roll comprising a cylindrical body having an outer diameter surface adapted and configured to bear against a web directed through the converting processing line, the outer diameter surface having a coating adapted and configured to repel adhesive and ink, the outer diameter surface having region with a plurality of circumferential grooves and adjacent circumferential lands, the circumferential grooves having an arcuate shape with a radius of between about 0.003 inches and about 0.007 inches after coating, the circumferential lands having an arcuate shape with a radius of between about 0.003 inches and about 0.007 inches after coating.

2. The roll of claim 1 wherein the coating is polymer based.

3. The roll of claim 1 wherein the region extends from adjacent one axial end of the cylindrical body to adjacent an opposite axial end of the cylindrical body.

4. The roll of claim 1 wherein a length of a groove in the plurality of grooves is between about 0.005 inches and about 0.010 inches after coating.

5. The roll of claim 1 wherein a length of a land in the plurality of lands is between about 0.005 inches and about 0.010 inches after coating.

6. The roll of claim 1 wherein a distance between centers of adjacent grooves in the plurality of grooves is between about 0.015 inches and about 0.020 inches after coating.

7. The roll of claim 1 wherein a distance between centers of adjacent lands in the plurality of lands is between about 0.015 inches and about 0.020 inches after coating.

8. The roll of claim 1 wherein the cylindrical body is disposed on a driving shaft.

9. The roll of claim 1 wherein the cylindrical body is disposed on a driven shaft.

10. The roll of claim 1 wherein the outer diameter surface has at least one circumferential flute adapted and configured to receive a contact assistance ring.

11. The roll of claim 10 wherein the region on the outer diameter surface having the plurality of grooves comprises at least one flat adjacent the at least one flute.

12. The roll of claim 11 wherein the plurality of grooves on the at least one flat is centered on the at least one flat.

13. The roll of claim 11 wherein a length of a groove in the plurality of grooves is between about 0.006 inches and about 0.012 inches after coating.

14. The roll of claim 11 wherein a length of a land in the plurality of lands is between about 0.006 inches and about 0.012 inches after coating.

15. The roll of claim 11 wherein a distance between centers of adjacent grooves in the plurality of grooves is between about 0.015 inches and about 0.020 inches after coating.

16. The roll of claim 11 wherein a distance between centers of adjacent lands in the plurality of lands is between about 0.015 inches and about 0.020 inches after coating.

17. The roll of claim 11 wherein the at least one flute comprises a plurality of flutes on the outer diameter surface of the cylindrical body.

18. The roll of claim 18, wherein adjacent flutes in the plurality of flutes are equally spaced on a portion of the outer diameter surface of the cylindrical body.
